(19) United States
(12) Patent Application Publication
(10) Pub. No.: US 2026/0238002 A1
(43) Pub. Date: Aug. 13, 2026

(54) AUXILIARY BATTERY FOR STANDBY APPLICATIONS IN AGRICULTURAL VEHICLES

(71) Applicant: CNH INDUSTRIAL AMERICA LLC, New Holland, PA (US)

(72) Inventors: Lakshmi Gopi Reddy, Plainfield, IL (US); Tadeja Kajtazi, Darien, IL (US)

(73) Assignee: CNH INDUSTRIAL AMERICA LLC, New Holland, PA (US)

(21) Appl. No.: 19/052,660

(22) Filed: Feb. 13, 2025

(51) Int. Cl. H02J 1/10; H02J 7/00; H02J 7/14

(52) U.S. Cl. CPC H02J 1/106; H02J 7/1423; H02J 7/485; H02J 7/855; H02J 2101/30; H02J 2105/37

(57) ABSTRACT

Systems, methods, and apparatus are disclosed. One system includes one or more processors configured to determine a first state associated with vehicle, the vehicle comprising one or more electronic components; select, responsive to determining the first state, a first power supply to supply power to at least one electronic component of the one or more electronic components, wherein the first power supply is operatively coupled with the at least one electronic component; identify a second state based on detecting a change or condition associated with at least one of the vehicle, the first power supply, or a second power supply; and select, responsive to identifying the second state, the second power supply to supply power to the at least one electronic component, wherein the second power supply is operatively coupled with the at least one electronic component.

### BACKGROUND

The present disclosure relates generally to vehicles. More specifically, the present disclosure relates to vehicles with agricultural applications.

### SUMMARY

In some embodiments, a vehicle (e.g., agricultural vehicle) may include multiple power supplies, such as a lead-acid battery and a lithium battery. As further described herein, each power supply may be selectively activated to supply power to various electronic components of the vehicle depending on the state of the vehicle (e.g., operational mode or standby mode) and/or various conditions, such as the passage of a predetermined time interval (e.g., 24 hours of standby mode), a state of charge associated with the lead-acid battery or lithium battery, or other conditions associated with vehicle components (e.g., engine speed). By selecting between multiple power supplies with different chemistries to power various vehicle components, the vehicle can efficiently distribute power and maintain continuous operation of certain components based on vehicle states and/or conditions, while ensuring an appropriate power supply is used to optimize battery performance and extend battery life.

In some aspects, the techniques described herein relate to a computer-implemented method including: determining, by one or more processors, a first state associated with a vehicle, the vehicle including one or more electronic components; selecting, by the one or more processors and responsive to determining the first state, a first power supply to supply power to at least one electronic component of the one or more electronic components; identifying, by the one or more processors, a second state based on detecting a change or condition associated with at least one of the vehicle, the first power supply, or a second power supply; and selecting, by the one or more processors and responsive to identifying the second state, the second power supply to supply power to the at least one electronic component.

In some aspects, the techniques described herein relate to a computer-implemented method, wherein selecting the second power supply includes: activating, by the one or more processors, at least one switch of the vehicle, wherein the at least one switch operatively couples the second power supply with the at least one electronic component.

In some aspects, the techniques described herein relate to a computer-implemented method, wherein the first power supply is a lead-acid battery and the second power supply is a lithium battery.

In some aspects, the techniques described herein relate to a computer-implemented method, wherein the first state corresponds with the vehicle being in an operational mode, and wherein the second state corresponds with the vehicle being in a standby mode.

In some aspects, the techniques described herein relate to a computer-implemented method, wherein the one or more electronic components include one or more switched loads and one or more unswitched loads, wherein the one or more unswitched loads include the at least one electronic component, and wherein selecting the first power supply includes: deactivating, by the one or more processors, the second power supply to prevent power from the second power supply to the one or more unswitched loads; and activating, by the one or more processors, the first power supply to power the one or more switched loads and the one or more unswitched loads.

In some aspects, the techniques described herein relate to a computer-implemented method, wherein selecting the second power supply includes: deactivating, by the one or more processors, the first power supply to prevent power from the first power supply to the one or more switched loads and the one or more unswitched loads; and activating, by the one or more processors, the second power supply to power the one or more unswitched loads.

In some aspects, the techniques described herein relate to a computer-implemented method, wherein the one or more electronic components include one or more switched loads, one or more unswitched loads, and one or more standby loads, wherein the one or more standby loads include the at least one electronic component, and wherein selecting the first power supply includes: deactivating, by the one or more processors, the second power supply to prevent power from the second power supply to the one or more standby loads; and activating, by the one or more processors, the first power supply to power the one or more switched loads, the one or more unswitched loads, and the one or more standby loads.

In some aspects, the techniques described herein relate to a computer-implemented method, wherein selecting the second power supply includes: deactivating, by the one or more processors, the first power supply to prevent power from the first power supply to the one or more standby loads and the one or more switched loads, wherein the first power supply powers the one or more unswitched loads; activating, by the one or more processors, the second power supply to power the one or more standby loads.

In some aspects, the techniques described herein relate to a vehicle including: one or more electronic components; a first power supply; a second power supply; and one or more processors configured to: determine a first state associated with the vehicle; select, responsive to determining the first state, the first power supply to supply power to at least one electronic component of the one or more electronic components, wherein the first power supply is operatively coupled with the at least one electronic component; identify a second state based on detecting a change or condition associated with at least one of the vehicle, the first power supply, or a second power supply; and select, responsive to identifying the second state, the second power supply to supply power to the at least one electronic component, wherein the second power supply is operatively coupled with the at least one electronic component.

In some aspects, the techniques described herein relate to a vehicle, the one or more processors configured to, in selecting the second power supply: activate at least one switch of the vehicle, wherein the at least one switch operatively couples the second power supply with the at least one electronic component.

In some aspects, the techniques described herein relate to a vehicle, wherein the first power supply is a lead-acid battery and the second power supply is a lithium battery.

In some aspects, the techniques described herein relate to a vehicle, wherein the first state corresponds with the vehicle being in an operational mode, and wherein the second state corresponds with the vehicle being in a standby mode.

In some aspects, the techniques described herein relate to a vehicle, wherein the one or more electronic components include one or more switched loads and one or more unswitched loads, wherein the one or more unswitched loads include the at least one electronic component, and wherein the one or more processors are configured to, in selecting the first power supply: deactivate the second power supply to prevent power from the second power supply to the one or more unswitched loads; and activate the first power supply to power the one or more switched loads and the one or more unswitched loads.

In some aspects, the techniques described herein relate to a vehicle, the one or more processors further configured to, in selecting the second power supply: deactivate the first power supply to prevent power from the first power supply to the one or more switched loads and the one or more unswitched loads; and activate the second power supply to power the one or more unswitched loads.

In some aspects, the techniques described herein relate to a vehicle, wherein the one or more electronic components include one or more switched loads, one or more unswitched loads, and one or more standby loads, wherein the one or more standby loads include the at least one electronic component, and the one or more processors further configured to, in selecting the first power supply: deactivate the second power supply to prevent power from the second power supply to the one or more standby loads; and activate the first power supply to power the one or more switched loads, the one or more unswitched loads, and the one or more standby loads.

In some aspects, the techniques described herein relate to a vehicle, the one or more processors further configured to, in selecting the second power supply: deactivate the first power supply to prevent power from the first power supply to the one or more standby loads and the one or more switched loads, wherein the first power supply powers the one or more unswitched loads; and activate the second power supply to power the one or more standby loads.

In some aspects, the techniques described herein relate to a system including: one or more processors configured to: determine a first state associated with vehicle, the vehicle including one or more electronic components; select, responsive to determining the first state, a first power supply to supply power to at least one electronic component of the one or more electronic components, wherein the first power supply is operatively coupled with the at least one electronic component; identify a second state based on detecting a change or condition associated with at least one of the vehicle, the at least one electronic component, the first power supply, or a second power supply; and select, responsive to identifying the second state, the second power supply to supply power to the at least one electronic component, wherein the second power supply is operatively coupled with the at least one electronic component.

In some aspects, the techniques described herein relate to a system, the one or more processors configured to, in selecting the second power supply: activate at least one switch of the vehicle, wherein the at least one switch operatively couples the second power supply with the at least one electronic component.

In some aspects, the techniques described herein relate to a system, wherein the first power supply is a lead-acid battery and the second power supply is a lithium battery.

In some aspects, the techniques described herein relate to a system, wherein the first state corresponds with the vehicle being in an operational mode, and wherein the second state corresponds with the vehicle being in a standby mode.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a driveline of the vehicle of FIG. 1, according to an exemplary embodiment.

FIGS. 4A-4B are flowcharts of processes for switching between multiple power supplies, according to an exemplary embodiment.

FIG. 5 is a schematic block diagram of circuitry of the vehicle of FIG. 1, according to an exemplary embodiment.

FIG. 6 is a schematic block diagram of circuitry of the vehicle of FIG. 1, according to an exemplary embodiment.

FIG. 7 is a schematic block diagram of circuitry of the vehicle of FIG. 1, according to an exemplary embodiment.

FIG. 8 is a flowchart of a process for switching between multiple power supplies, according to an exemplary embodiment.

FIG. 9 is a flowchart of a process for switching between multiple power supplies, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Agricultural vehicles may include various components, which may consume electrical power while the vehicle is operating and while the vehicle is no longer in use. While some electrical components may be powered off while the vehicle is no longer operating (e.g., in a standby mode), certain electrical components may still receive power. Traditionally, vehicles include a lead-acid battery to power electronic components during both operation and standby, but lead-acid batteries may be insufficient for standby loads in various applications. For example, in applications where the vehicle is used intermittently (e.g., long off-times between on-times) and/or includes multiple standby loads (e.g., multiple components being powered), prolonged use of lead-acid batteries can cause various issues. For example, lead-acid batteries are generally not configured for deep cycling, which may occur during standby applications. Deep cycling may refer to discharging a battery to a significant depth of an overall capacity of the battery (e.g., below 50%) and then fully recharging the battery, which can cause lead-acid batteries to lose ability to hold a charge effectively, reduce battery capacity and efficiency over time, and potentially lead to premature failure. Further, the use of such lead-acid batteries for both operational and standby applications can cause sulfation, which may reduce battery life and/or lifespan. Additionally, power demands during standby periods may cause excessive discharge rates of lead-acid batteries, further decreasing battery life and compromising long-term battery health. Because lead-acid batteries may be used as starter batteries for vehicles, battery degradation caused by deep cycling, sulfation, or standby power demands can lead to insufficient charge and may cause a vehicle using the lead-acid battery for ignition to fail to power on when an operator attempts to start the vehicle.

However, lead-acid batteries offer benefits in various applications. For example, lead-acid batteries may be used in cold climates (e.g., environments which increase the internal resistance of the battery) because lead-acid batteries use a chemical reaction between lead dioxide and sulfuric acid to produce energy, which is less affected by temperature changes compared to the electrolyte chemistry used in lithium batteries. Further, lead-acid batteries may provide a high initial current draw for starting a vehicle, or for powering heavy loads during operation. In contrast, lithium-ion batteries may be used for providing consistent power during low-current draw periods, such as powering electronics over extended-off or standby periods. In some embodiments, vehicles, including agricultural vehicles, may benefit from including both types of batteries to balance power distribution and optimize performance of various components in both operational and standby modes.

While lithium (or lithium-ion) batteries may have higher energy density and greater depth of discharge capabilities compared to lead-acid batteries, integrating lithium batteries into agricultural vehicles that include lead-acid batteries presents various technical challenges. For example, one challenge involves managing the simultaneous charge or discharge of different battery types. Lithium and lead-acid batteries operate with different chemistries, which can result in imbalanced charging rates, voltage mismatches, or thermal issues. If both types are charged or discharged simultaneously without proper control, overcharging or overheating may occur in one battery type, which may cause battery system failures or other operational hazards. Another challenge includes managing varying power demands of different vehicle components. Some electronic components, such as sensors, may consume low or minimal power, while others, such as displays or processing units, may have much higher relative power demands. A further challenge includes controlling different charging and discharging characteristics of lithium and lead-acid batteries to avoid inefficiencies. For example, lithium batteries typically charge faster and allow deeper discharges, while lead-acid batteries may use slower and more controlled charging cycles. Without proper management, either the lithium or lead-acid battery may be being overused or underutilized.

According to various embodiments, a system is provided for switching between multiple power supplies, such as a lead-acid battery and a lithium battery. Generally, the system may be implemented in a vehicle (e.g., an agricultural vehicle, a road vehicle, a construction vehicle, an aerial vehicle, a marine vehicle, an off-road vehicle, a recreational vehicle, etc.) and may be configured to optimize the use of different battery chemistries to address challenges related to vehicle standby power consumption and system efficiency. In some embodiments, the system may include one or more relays or switches that control a flow of electricity between multiple power supplies and one or more electronic components of the vehicle based on the state of the vehicle or vehicle components, or based on other conditions (e.g., passage of a predetermined time, environmental factors, etc.). Generally, the system (e.g., vehicle) may include a first power supply, such as a lead-acid battery, and a second power supply, such as a lithium battery. The system may also include one or more electronic components that may use power during different operational states of the vehicle, such as during operational (e.g., active driving or key-on) mode or in standby mode (e.g., key-off mode). In some embodiments, the system may selectively activate either the first power supply or the second power supply based on the current state of the vehicle, the specific power used by electronic components of the vehicle, and/or other conditions, as further described herein.

### Overall Vehicle

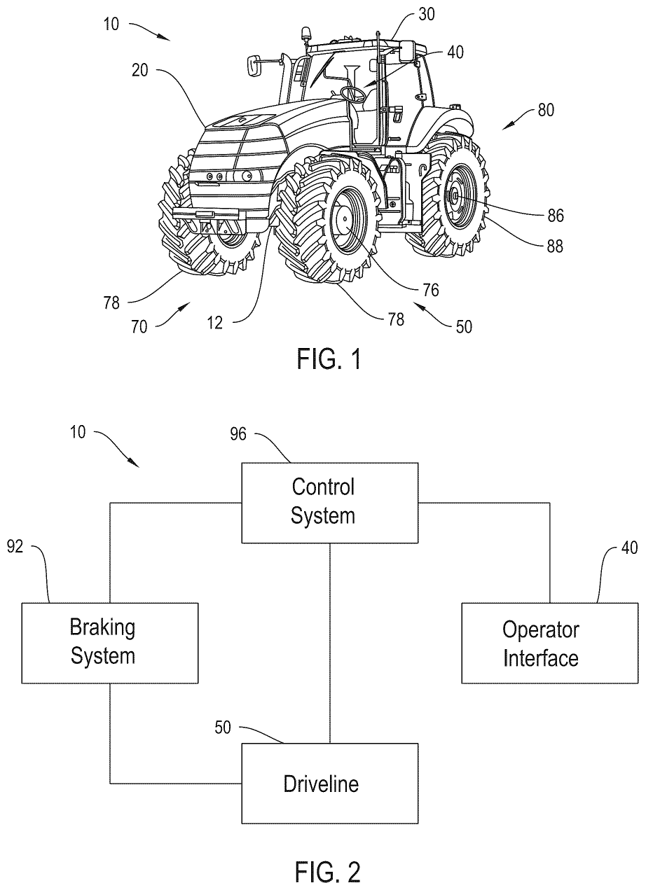

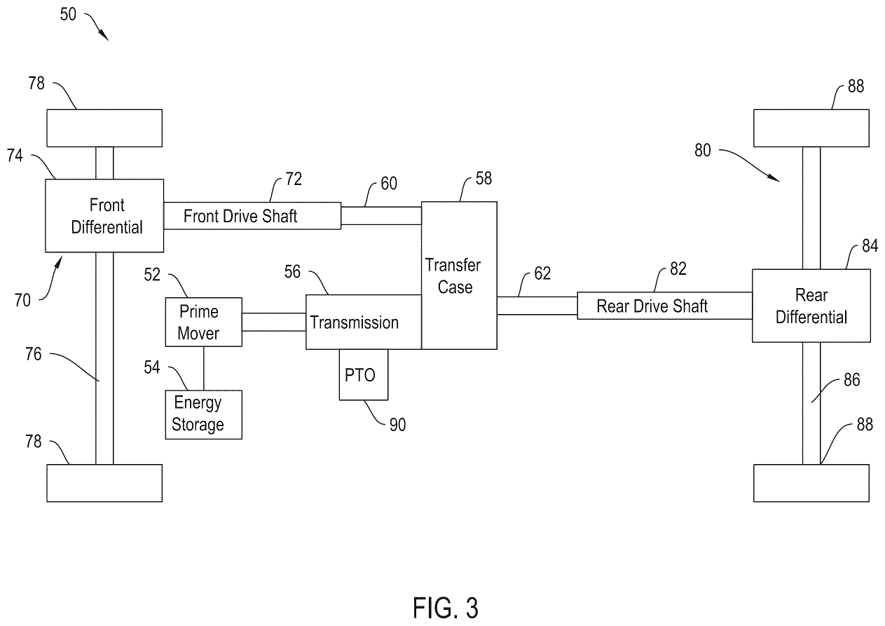

According to the exemplary embodiment shown in FIGS. 1-3, a machine or vehicle (e.g., a non-articulated vehicle, an articulated vehicle, etc.), shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 92, coupled to one or more components of the driveline 50 to facilitate selectively braking the one or more components of the driveline 50; and a vehicle control system, shown as control system 96, coupled to the operator interface 40, the driveline 50, and the braking system 92. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 56) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, an LCD display, a LED display, a speedometer, gauges, warning lights, etc. The one or more input device may be or include a steering wheel, a joystick, buttons, switches, knobs, levers, an accelerator pedal, a brake pedal, etc.

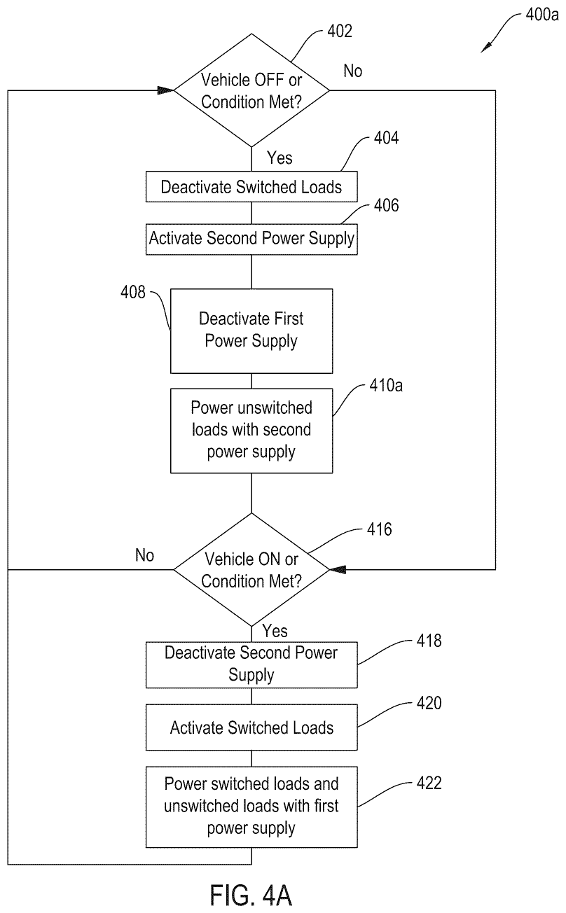

According to an exemplary embodiment, the driveline 50 is configured to propel the vehicle 10. As shown in FIG. 3, the driveline 50 is an electric driveline that includes a primary driver (e.g., prime mover, etc.), shown as electric motor 52, and an energy storage system (e.g., energy storage, etc.), shown as high voltage system 54. For example, the electric motor 52 may be electrically coupled to (e.g., in electrical communication with, etc.) the high voltage system 54 and may consume electrical energy from the high voltage system 54 in order to propel the vehicle 10. In some embodiments, the driveline 50 is a fuel cell electric driveline that includes the electric motor 52 and the energy storage system is a fuel cell (e.g., that stores hydrogen, that produces electricity from the hydrogen, etc.). In some embodiments, the driveline 50 is a hybrid driveline that includes (i) the electric motor 52 and an internal combustion engine and (ii) the high voltage system 54 and a fuel tank. In other embodiments, the driveline 50 is a conventional driveline where the primary driver is an internal combustion engine and the energy storage system is a fuel tank. The internal combustion engine may be a spark-ignition internal combustion engine or a compression-ignition internal combustion engine that may use any suitable fuel type (e.g., diesel, ethanol, gasoline, natural gas, propane, etc.).

As shown in FIG. 3, the driveline 50 includes a transmission device (e.g., a gearbox, a continuous variable transmission (“CVT”), etc.), shown as transmission 56, coupled to the electric motor 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the electric motor 52. In some embodiments (e.g., in electric driveline configurations, in hybrid driveline configurations, etc.), the driveline 50 does not include the transmission 56. In such embodiments, the electric motor 52 may be directly coupled to the transfer case 58. According to an exemplary embodiment, the transfer case 58 is configured to facilitate driving both the front tractive assembly 70 and the rear tractive assembly 80 with the electric motor 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the electric motor 52 (e.g., to permit free movement of the front tractive assembly 70 and the rear tractive assembly 80 in a neutral mode of operation). In some embodiments, the driveline 50 does not include the transfer case 58. In such embodiments, the electric motor 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the electric motor 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the electric motor 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of the electric motors 52. By way of example, the driveline 50 may include a first of the electric motors 52 that drives the front tractive assembly 70 and a second of the electric motors 52 that drives the rear tractive assembly 80. By way of another example, the driveline 50 may include a first of the electric motors 52 that drives a first one of the front tractive elements 78, a second of the electric motors 52 that drives a second one of the front tractive elements 78, a third of the electric motors 52 that drives a first one of the rear tractive elements 88, and/or a fourth of the electric motors 52 that drives a second one of the rear tractive elements 88. By way of still another example, the driveline 50 may include a first of the electric motors 52 that drives the front tractive assembly 70, a second of the electric motors 52 that drives a first one of the rear tractive elements 88, and a third of the electric motors 52 that drives a second one of the rear tractive elements 88. By way of yet another example, the driveline 50 may include a first of the electric motors 52 that drives the rear tractive assembly 80, a second of the electric motors 52 that drives a first one of the front tractive elements 78, and a third of the electric motors 52 that drives a second one of the front tractive elements 78. In such embodiments, the driveline 50 may not include the transmission 56 and/or the transfer case 58 or may include multiple of the transmissions 56 and/or the transfer cases 58 (e.g., one of the transmissions 56 and/or one of the transfer cases 58 for each of the electric motors 52, etc.).

As shown in FIG. 3, the driveline 50 includes a power-take-off (“PTO”), shown as PTO 90. While the PTO 90 is shown as being an output of the transmission 56, in other embodiments the PTO 90 may be an output of the electric motor 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 92 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 92 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

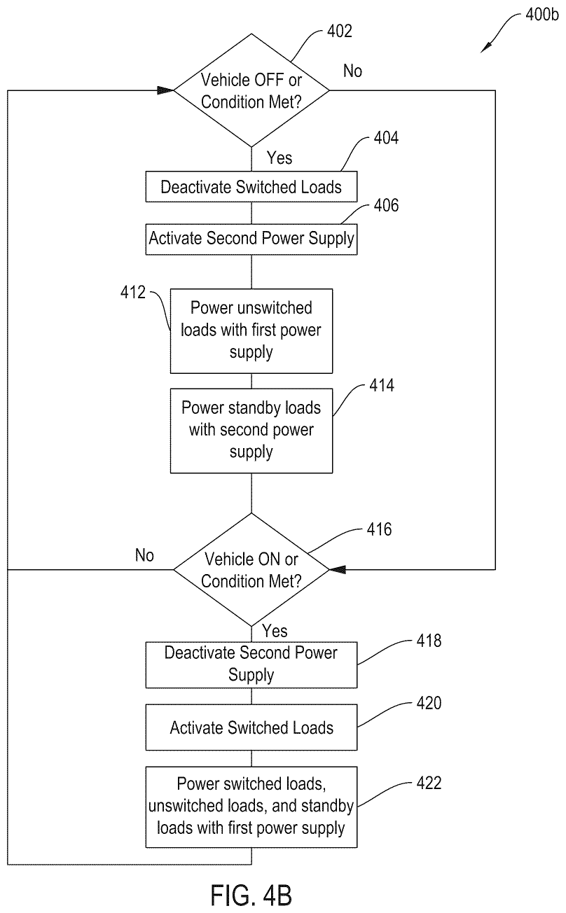

Referring generally to FIGS. 4A-4B, flowcharts of processes 400a-400b for switching between multiple power supplies are shown. In some embodiments, process 400a and/or 400b may be executed or implemented by one or more components or systems of FIGS. 1-3 (e.g., vehicle 10) and/or by one or more processors of vehicle 10. In some embodiments, process 400a and/or 400b may be executed or implemented by one or more components or systems of FIGS. 4-7. Generally, the steps of process 400a and/or 400b can be executed sequentially or in parallel (e.g., steps 404 and 406 can be performed in parallel). It should be understood that, in other embodiments, the steps of process 400a and/or 400b may be performed in any order, combined, and/or additional modifications implemented, such as the deletion of one or more steps and/or the addition of one or more steps.

Referring to FIG. 4A, a flowchart of a process 400a for switching between multiple power supplies is shown, according to an exemplary embodiment. In some embodiments, at step 402, the process 400a may include determining if a vehicle is in an OFF state or if a condition is met. In some embodiments, step 402 may include detecting a key-off state associated with the vehicle or otherwise identifying a change to a standby mode. Further, determining if a condition is met at step 402 may include analyzing or determining vehicle use cases (e.g., idling, active driving, or parking), environmental conditions (e.g., rainy weather, day/nighttime), information about power supplies (e.g., battery statistics or charge levels), alternator outputs, and various additional data (e.g., user inputs). In some embodiments, at or before step 408, a first power supply (e.g., lead-acid battery or any electrochemical energy storage system configured to provide high-current output) may power various electronic components of the vehicle (e.g., switched loads and unswitched loads) and be selectively activated and deactivated as further described herein.

In some embodiments, at step 404, the process 400a may include deactivating one or more switched loads. For example, switched loads may include electronic components such as lights or accessories that are powered off or deactivated when the vehicle enters a standby or OFF state, as compared with unswitched loads, which are powered in both ON and OFF states associated with the vehicle. In some embodiments, deactivating the switched loads at step 404 may reduce power consumption when the vehicle is not in use by preventing power from flowing from the first power supply to various electronic components of the vehicle. In some embodiments, at step 406, the process 400a may include activating a second power supply (e.g., lithium battery or any energy storage system configured to provide sustained power delivery over extended periods).

In some embodiments, at step 408, the process 400a may include deactivating the first power supply. For example, the first power supply may be deactivated while the vehicle is in a standby state by preventing power from flowing from the first power supply (e.g., lead-acid battery) to any loads (e.g., unswitched loads and switched loads). In some embodiments, at step 410, the process 400a may include powering unswitched loads with the second power supply. For example, the second power supply (e.g., lithium battery) may power unswitched loads including electronic components such as a processing and connectivity module (PCM), a display, and/or a receiver during standby mode.

In some embodiments, at step 416, the process 400a may include determining if the vehicle is in an ON state or if a condition is otherwise met. For example, step 416 may include detecting the vehicle being started or activated and/or receiving a signal (e.g., including vehicle state, battery health or charge state, environmental conditions, etc.). In some embodiments, at step 418, the process 400a may include deactivating the second power supply. For example, the second power supply may be deactivated at step 418 based on detecting the vehicle transitioning or changing to an operational state from an OFF state or standby mode. In some embodiments, at step 420, the process 400a may include activating switched loads. For example, components such as lights or displays may be powered back on as the vehicle returns to operational or key-on mode. In some embodiments, at step 422, the process 400a may include powering switched loads and unswitched loads with the first power supply. For example, during operational mode, the lead-acid battery may resume powering some or all components of the vehicle.

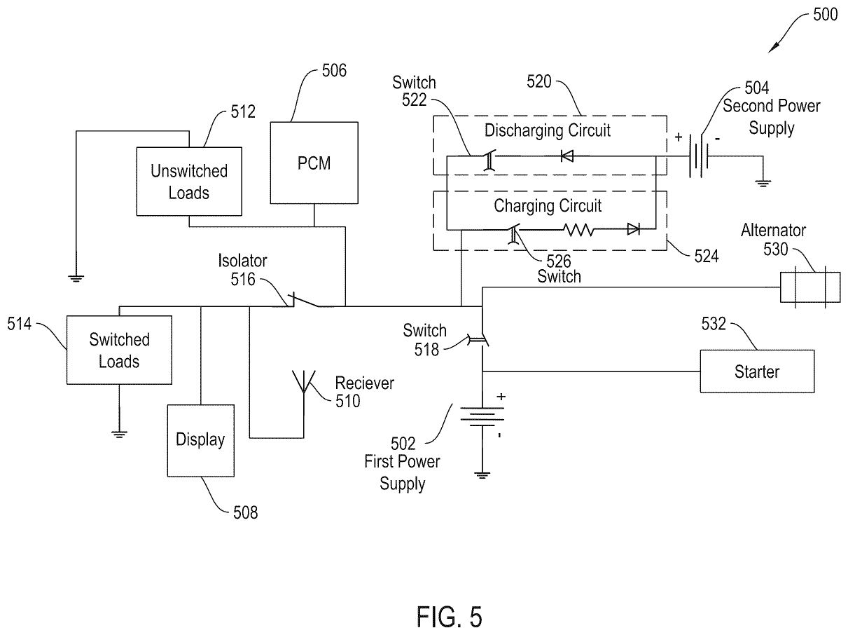

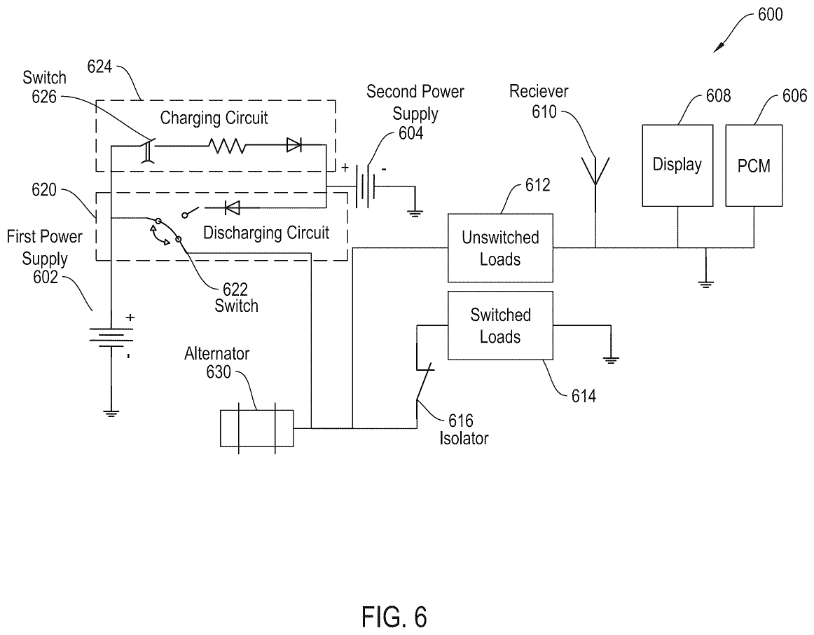

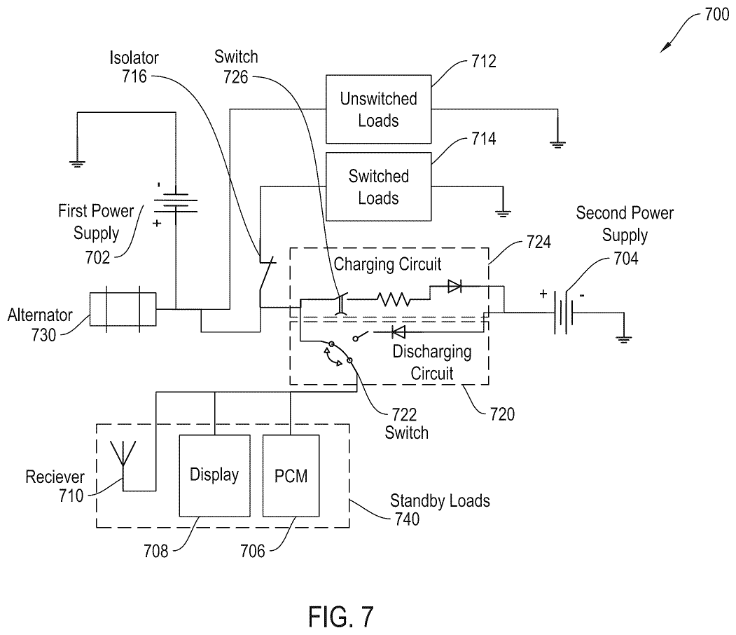

In some embodiments, FIG. 4A, FIG. 5, and FIG. 6 illustrate embodiments including unswitched loads and switched loads, where the second power supply powers unswitched loads during standby and the first power supply is inactive during standby, as described regarding process 400a. In other embodiments, FIG. 4B and FIG. 7 illustrate embodiments including unswitched loads, switched loads, and standby loads, where the second power supply powers standby loads during standby and the first power supply powers unswitched loads, as further described regarding process 400b herein.

In some embodiments, switched loads, unswitched loads, and standby loads may refer to categories or groups of electronic components within a vehicle. Switched loads may include components that are deactivated when the vehicle is in standby or key-off mode, such as in-cabin electronics, lights, or entertainment systems that do not use continuous power. In contrast, unswitched loads may include components that remain powered during both operational and standby modes (e.g., sensors, basic lighting, or other low-power components that support minimal vehicle functionality when the vehicle is not in use). Similarly, standby loads may include a group of components that remain active or powered when the vehicle is in standby or key-off mode and also remain active or powered during operation.

Referring now to FIG. 4B, a process 400b for selecting between multiple power supplies is shown, according to an exemplary embodiment. As described above regarding FIG. 4A and process 400a, the process 400b may include determining if a vehicle is in an OFF state or if a condition is met at step 402, deactivating one or more switched loads at step 404, and activating a second power supply at step 406. In some embodiments, at step 412, the process 400b may include powering unswitched loads with the first power supply. For example, at step 412, power from the lead-acid battery can be removed from the switched loads, and power can be provided from the lead-acid battery to the unswitched loads.

In some embodiments, at step 414, the process 400b may include further include powering standby loads with the second power supply. For example, during standby or key off mode, the first power supply may power unswitched loads while the second power supply powers standby loads. In some embodiments, the process 400b may further include determining if the vehicle is in an ON state or if a condition is otherwise met at step 416 and activating switched loads at step 420, as described above regarding FIG. 4A and process 400b. In some embodiments, at step 422, the process 400b may include powering switched loads, unswitched loads, and standby loads with the first power supply.

Referring to FIG. 5, a schematic block diagram of circuitry 500 of the vehicle of FIG. 1 is shown, according to an exemplary embodiment. In some embodiments, circuitry 500 includes a first power supply 502, a second power supply 504, a powertrain control module (PCM) 506, a display 508, a receiver 510, unswitched loads 512, switched loads 514, isolator 516, switch 518, discharging circuit 520, charging circuit 524, alternator 530, and starter 532. The discharging circuit 520 may include switch 522. The charging circuit 524 may include switch 526. In other embodiments, circuitry 500 may include additional components, fewer components, or alternative components. For example, the circuitry 500 may include various diodes, resistors, relays, and other electronic components, as shown in FIG. 5. In some embodiments, each of the components of FIG. 5 may be operatively coupled via one or more cables or wires (e.g., electrical wires). Generally, circuitry 500 is configured to select between a first power supply (lead-acid battery) 502 and a second power supply (lithium battery) 504 to power one or more electronic components, depending on a state of a system or vehicle including circuitry 500 (e.g., vehicle 10) and/or other conditions.

In some embodiments, circuitry 500 includes the first power supply 502. In some embodiments, the first power supply 502 is or includes a lead-acid battery to power various electronic components of a vehicle including circuitry 500. Generally, a lead-acid battery may refer to a type of rechargeable battery that operates through the chemical reaction between lead dioxide, lead, and sulfuric acid, which produces electrical energy. In some embodiments, the first power supply 502 may supply power during operational modes (e.g., vehicle ignition or regular operation) and/or standby modes. As shown in FIG. 5, the first power supply 502 may be operatively coupled to various power management components such as switches, relays, or isolators to control power distribution to different loads. Generally, in the embodiment shown in FIG. 5, the first power supply 502 may power PCM 506, display 508, receiver 510, unswitched loads 512, and switched loads 514 during periods of vehicle activity (e.g., key-on or operational modes).

For example, the first power supply 502 may be operatively coupled to the switch 518 such that activation of the switch 518 forms an electrical connection between the first power supply 502 and at least one electronic component of circuitry 500 (e.g., PCM 506, unswitched loads 512, etc.), and deactivation of the switch 518 deactivates the electrical connection between the first power supply 502 and other components of circuitry 500. In some examples, the first power supply 502 may provide power to unswitched loads 512 and/or switched loads 514 based on a state (e.g., standby or operational mode) associated with vehicle 10, conditions or states associated with electronic components of circuitry 500 (e.g., a battery state of charge (SOC) associated with the first power supply 502 and/or second power supply 504), or other conditions, such as the passage of a predetermined time.

In some embodiments, predetermined times may refer to intervals or periods (e.g., 30 minutes, 24 hours, etc.) associated with the operation of a vehicle or non-use of a vehicle, or associated with components of circuitry 500 (e.g., first power supply 502, second power supply 504, etc.). For example, after detecting that a period of time (e.g., 30 minutes of operation) has passed since the vehicle entered operational mode, switch 526 may activate to charge the second power supply 504 using the first power supply 502 or alternator 530. Further, in response to detecting that a period of time (e.g., 24 hours of standby) has passed since the vehicle entered standby mode, switch 518 may activate to reconnect the first power supply 502 and power components that were previously powered by the second power supply 504 in standby mode (e.g., unswitched loads 512). In some embodiments, one or more switches may activate based on various additional or alternative intervals which cause similar adjustments to power distribution based on vehicle conditions, states or conditions of components of circuitry 500, and/or time intervals. That is, intervals used to activate and/or deactivate the first power supply 502 and/or second power supply 504 may be dynamic and adjust based on detected conditions of the vehicle or components (e.g., battery health or system demands). For example, detecting that the second power supply 504 has reached a low state of charge (e.g., below a threshold) may trigger switch 526 to activate prior to the passage of an interval (e.g., prior to detecting 30 minutes of operational mode). Additionally, detecting an increase in power demand from unswitched loads 512 during standby mode may prompt switch 518 to activate prior to the passage of an interval (e.g., prior to detecting 24 hours of standby mode).

In some embodiments, circuitry 500 includes second power supply 504. In some embodiments, the second power supply 504 is or includes a lithium battery to power various electronic components of a vehicle including circuitry 500. Generally, a lithium battery may refer to a type of rechargeable battery that operates through the movement of lithium ions between a positive and negative electrode, which generates electrical energy. In some embodiments, the second power supply may supply power during standby modes (e.g., key-off modes) and/or operational modes (e.g., key-on modes). As shown in FIG. 5, the first power supply 502 may be operatively coupled to various components such as switches, relays, or isolators to control power distribution to different loads. Generally, in the embodiment shown in FIG. 5, the second power supply 504 may power PCM 506 and unswitched loads 512 during periods of vehicle inactivity (e.g., standby or extended standby).

As described above, the circuitry 500 may include one or more electronic components. For example, as shown in FIG. 5, the circuitry 500 includes PCM 506, display 508, receiver 510, unswitched loads 512, and switched loads 514. In some embodiments, powering the unswitched loads 512 and/or the switched loads 514 may include powering one or more of the PCM 506, display 508, and receiver 510, and may further include powering one or more additional electronic not shown in FIG. 5 (e.g., cabin lights, horns, air conditioning systems, sensors, additional processors, additional displays or receivers, etc.).

In some embodiments, the circuitry 500 includes PCM 506. Generally, PCM 506 may refer to a processing and connectivity module or another processing system configured to manage vehicle data, control signals, electricity/power flow, and/or communications. For example, PCM 506 may process vehicle operations data, communicate between internal vehicle components (e.g., to alternate between power supplies), and/or interface with external systems (e.g., software applications, other agricultural equipment, etc.) to coordinate various functions. In some embodiments, PCM 506 may provide guidance for agricultural or farming applications, such as agronomic data storage (e.g., soil and crop data) and telematics via a cellular modem for remote monitoring. Further, PCM 506 may connect with vehicle guidance systems or farm management software and execute processes such as automated navigation, data logging, or sending alerts/messages.

In some embodiments, the circuitry 500 includes display 508. Generally, display 508 may refer to any type of display screen, such as an LCD display, LED display, touchscreen, or another visual interface. In some embodiments, display 508 may be configured as an operator interface (e.g., as described regarding operator interface 40 of FIG. 1) used by an operator to control a vehicle, and may include features or components such as guidance systems, GPS modules, and other systems to facilitate precision farming applications. In other embodiments, the display 508 may be display various data, such as maps or plots, general information corresponding to the vehicle, entertainment content, audio, and so on. Further, display 508 may be modular and include multiple displays, such as a primary display and a secondary display. Additionally, display 508 may interface with sensors or components, such as receiver 510, and may display various types of data, such as navigation data, system status, or diagnostic information. For example, GNSS data from receiver 510 may be presented to the operator through display 508 to assist with navigation and precision farming tasks.

In some embodiments (e.g., as shown in FIG. 5), the display 508 may be included with or categorized as a switched load, such that the display 508 is deactivated in standby modes but activated during operational modes. In other embodiments further described herein (e.g., as shown in FIG. 6), display 508 or a similar display may be included with or categorized with unswitched loads such that the display is powered in both standby modes and operational modes. Further still, in some embodiments (e.g., as shown in FIG. 7), the display 508 or a similar display may be included with standby loads that may remain powered in both standby modes and operational modes. In some embodiments, display 508 may be powered by first power supply 502 during vehicle operation, but in other configurations, second power supply 504 may power the display during standby or extended standby periods.

In some embodiments, circuitry 500 includes unswitched loads 512. Generally, unswitched loads 512 may refer to electronic components that use power (e.g., a constant power supply) in both operational and standby modes, such as control modules and sensors that monitor the vehicle during both active and standby periods, lights or displays, and so on. In the embodiment shown in FIG. 5, the unswitched loads 512 may be powered by the first power supply 502 during operation of the vehicle, and may be powered by second power supply 504 during standby. In some examples, alternating between power supplies may to preserve the charge of the first power supply 502 (e.g., to maintain operations continuously) and improve operating times or system performance (e.g., for high-demand tasks such as starting the vehicle, etc.).

In some embodiments, circuitry 500 includes switched loads 514. Generally, switched loads 514 may refer to electronic components that are selectively powered based on the vehicle's state. For example, switched loads 514 may be activated during operational modes (e.g., ON during vehicle operation) and deactivated during standby modes (e.g., OFF when the vehicle is not in use). Generally, switched loads 514 include components such as in-cabin electronics, lighting systems, and other devices used primarily during vehicle operation. As shown in FIG. 5, the first power supply 502 may power the switched loads 514 during active vehicle operation.

In some embodiments, the circuitry 500 may include isolator 516. Generally, isolator 516 may refer to a component (e.g., switch) configured to manage electrical power distribution between power supplies and various vehicle loads by connecting or disconnecting circuits. That is, the isolator 516 may function similarly to a switch, but may include additional features or components to manage power flow direction and/or prevent backflow between power sources. In some embodiments, during operational mode, the isolator 516 may activate to operatively couple the first power supply 502 to both the unswitched loads 512 and the switched loads 514. Further, in standby mode, the isolator 516 may be deactivated to prevent power from flowing from the second power supply 504 to the switched loads 514 (e.g., to direct power to the unswitched loads 512). In some embodiments, the isolator 516 is controlled by PCM 506 (e.g., through the SFB) to manage power paths as the vehicle transitions or changes between states (e.g., from operational mode to standby mode).

In some embodiments, the circuitry 500 includes one or more switches, such as the isolator 516, switch 518, switch 522, and switch 526. Generally, each switch can regulate power distribution between the first power supply 502 and the second power supply 504 and the various loads (e.g., switched loads 514 and unswitched loads 512). Generally, each of the switches may operate bi-directionally or multi-directionally to control power flow based on the vehicle state or other conditions. For example, isolator 516, which may be referred to as a current battery isolator, may manage the connection between the first power supply 502 and the loads, such as switched and unswitched loads. In another example, switch 518, which may be referred to as a lead-acid battery disconnect relay, may control the disconnection of the first power supply 502 from various components. Further, switch 522, which may be referred to as a lithium discharge circuit relay, may direct or supply power from the second power supply 504 to the unswitched loads during standby mode. Similarly, switch 526, which may be referred to as the lithium charge circuit relay, may control the charging of the second power supply 504 through the first power supply 502 or through external sources, such as the alternator 530.

In some embodiments, the isolator 516, switch 518, and switch 526 may be controlled by a smart fuse box (SFB). For example, the SFB may be or include a control system configured to actively connect or disconnect electrical connections between the isolator 516, switch 518, and switch 526 and between other components of circuitry 500. That is, the SFB may control the flow of power between the first power supply 502, the second power supply 504, and various loads. Further, as shown in FIG. 5, switch 522 may be controlled by a universal control module (UCM). For example, the UCM may be or include a control system that activates or deactivates switch 522 (e.g., to direct power from the second power supply 504 to the unswitched loads 512 during standby mode). In some embodiments, the PCM 506 may interface with the SFB and UCM to coordinate the activation of various switches. For example, the PCM 506 may control the activation of the isolator 516 to connect the first power supply 502 to the unswitched loads 512 during operational mode, and may instruct the UCM to activate switch 522 to power unswitched loads 512 using the second power supply 504 during standby mode.

In some examples, the operation of one or more of isolator 516, switch 518, switch 522, and switch 526 may be synchronized to maintain continuous power flow during transitions or changes between states. For example, switch 522 may include a switch time of approximately 2 milliseconds, while switch 518 may include a switch time of approximately 10 milliseconds such that an overlap exists between activation of each of the switches. In some embodiments, the overlap in switching times may prevent disruptions to the unswitched loads and provide continuous power flow to maintain operation of certain electronic components (e.g., PCM 506) in both standby and operational modes.

As illustrated in FIG. 5, one or more of switch 518, switch 522, and switch 526 may be configured as two-pole switches. Generally, a two-pole switch may refer to a switch capable of controlling two separate circuits simultaneously and providing independent control of power flow to various components or loads. In some embodiments, including a two-pole configuration enables one or more of switch 518, switch 522, or switch 526 to connect or disconnect the first power supply 502 or second power supply 504 to supply power to different vehicle loads or electronic components.

As shown in FIG. 5, the second power supply 504 is operatively coupled with discharging circuit 520 and charging circuit 524. Generally, discharging circuit 520 and charging circuit 524 may control the charge and discharge of the second power supply 504 for various purposes (e.g., to charge a lithium battery for use during standby modes, to prevent dangerous overuse or limit simultaneous use of the second power supply 504 with first power supply 502, etc.). In some examples, the switch 522 of the discharging circuit 520 may be activated (e.g., closed) to operatively couple the second power supply 504 to the at least one electronic component (e.g., PCM 506) for discharge (e.g., to power the electronic component). For example, the second power supply 504 may be operatively coupled to the switch 522 such that activation of the switch 522 forms an electrical connection between the second power supply 504 and at least one electronic component of circuitry 500 (e.g., PCM 506, unswitched loads 512, etc.), and deactivation of the switch 522 deactivates the electrical connection between the second power supply 504 and other components of circuitry 500. In some examples, each of the discharging circuit 520 and charging circuit 524 may include a diode and/or resistor to prevent backflow of electricity that may cause damage the second power supply 504.

In some embodiments, the switch 522 of the discharging circuit 520 may be activated (e.g., closed) to operatively couple the second power supply 504 to various electronic components, such as PCM 506 and unswitched loads 512. In some examples, the switch 522 may be activated based on detecting or identifying historical or current data or conditions associated with the vehicle or included components. For example, the switch 522 may be activated such that the second power supply 504 provides electrical power in response to the vehicle entering key-off or standby mode. Further, the switch 522 may be deactivated to prevent power from flowing from the second power supply 504 in response to determining the second power supply 504 has provided power for a period (e.g., 24 hours) or depending on the SOC of the second power supply 504. In some embodiments, the operation of switch 522 and switch 518 may be mutually exclusive. For example, activation of switch 522 may cause deactivation of switch 518, and activation of switch 518 may cause deactivation of switch 522. Generally, the switch 518 and switch 522 may include a period of overlap time (e.g., 10 milliseconds) such that the unswitched loads 512 are continuously powered.

Further, the switch 526 of the charging circuit 524 may be activated (e.g., closed) to operatively couple the second power supply 504 to the first power supply 502 or alternator 530 such that the first power supply 502 or alternator 530 provide electrical power for charging the second power supply 504. For example, the switch 526 may be activated in response to the vehicle operating in a key-on or operational state for a period at full engine speed (e.g., thirty minutes) or idle speed (e.g., one hour). In some embodiments, the switch 526 may be activated based on a state of charge (SOC) of the second power supply 504 (e.g., in response to detecting low lithium battery power).

In some embodiments, the circuitry 500 may include the alternator 530. Generally, alternator 530 may refer to a device that converts mechanical energy into electrical energy to charge the battery systems and/or supply electrical power to electronic components. In some embodiments, the alternator 530 may charge the first power supply 502 (e.g., lead-acid battery) during operational mode using mechanical energy produced by an engine of the vehicle. In some embodiments, the alternator 530 may further provide electrical power directly to various vehicle components (e.g., switched loads 514) while the vehicle is operational. For example, when the vehicle is in an operational or key-on state and the switch 518 is open, the alternator 530 may receive energy from the engine and convert the received energy to electrical energy, which can then be distributed to charge the second power supply 504 and/or power various vehicle loads. In some embodiments, when switch 518 is closed, the alternator 530 may provide power to the first power supply 502, the second power supply 504, and/or other electronic components.

In some embodiments, the circuitry 500 may include the starter 532. Generally, the starter 532 is configured to initiate vehicle startup by drawing electrical power from a power supply to crank an engine or drive an electric motor. The first power supply 502 (e.g., a lead-acid battery) may provide sufficient current to the starter 532 during vehicle startup. For example, in a vehicle with an internal combustion engine (ICE) or hybrid configuration, the first power supply 502 may be used to provide a high current to start the engine. In other embodiments, such as in a fully electric vehicle, the second power supply 504 (e.g., a lithium battery) may be used to power the starter 532 to engage an electric motor during startup. In some embodiments, the starter 532 may selectively draw power from either the first power supply 502 or the second power supply 504 based on vehicle state or other conditions (e.g., whether the vehicle is operating in ICE mode, hybrid mode, or full-electric mode).

Referring to FIG. 6, a schematic block diagram of circuitry 600 of the vehicle of FIG. 1 is shown, according to an exemplary embodiment. In some embodiments, the circuitry 600 includes a first power supply 602, a second power supply 604, a powertrain control module (PCM) 606, a display 608, a receiver 610, unswitched loads 612, switched loads 614, isolator 616, switch 618, discharging circuit 620, charging circuit 624, and alternator 630. The discharging circuit 620 may include switch 622, and the charging circuit 624 may include switch 626. In other embodiments, circuitry 600 may include additional components, fewer components, or alternative components. For example, the circuitry 600 may include various diodes, resistors, relays, and other electronic components, as shown in FIG. 6. In some embodiments, each of the components of FIG. 6 may be operatively coupled via one or more cables or wires (e.g., electrical wires). Generally, circuitry 600 illustrates a configuration in which display 608 is included with unswitched loads 612. That is, unlike the configuration shown in FIG. 5, display 608 remains powered during both operational and standby modes and may receive continuous power from either the first power supply 602 or the second power supply 604 depending on vehicle state.

In some embodiments, the various switches of circuitry 600 may regulate power flow depending on the vehicle state (e.g., operational or standby mode) or other conditions. For example, during key-off or standby mode, switch 622 in the discharging circuit 620 may close and direct power from the second power supply 604 (e.g., lithium battery) to unswitched loads 612 (e.g., components using less than 15 milliamps of current). As shown in FIG. 6, the unswitched loads 612 may include display 608. In some embodiments, during operational mode of the vehicle, switch 618 and isolator 616 may close to connecting the first power supply 602 (e.g., lead-acid battery) to both unswitched loads 612 and switched loads 614. In some embodiments, after a period of vehicle operation (e.g., 30 minutes), switch 626 of the charging circuit 624 may close and cause the alternator 630 or first power supply 602 to charge second power supply 604. In some embodiments, the first power supply 602 may activate after a period (e.g., 24 hours) of standby or when the vehicle changes to the operational or key-on mode.

Referring to FIG. 7, a schematic block diagram of circuitry 700 of the vehicle of FIG. 1 is shown, according to an exemplary embodiment. In some embodiments, the circuitry 700 includes a first power supply 702, a second power supply 704, a powertrain control module (PCM) 706, a display 708, a receiver 710, unswitched loads 712, switched loads 714, isolator 716, discharging circuit 720, charging circuit 724, and alternator 730. The discharging circuit 720 may include switch 722, and the charging circuit 724 may include switch 726. The circuitry 700 can include one or more standby loads 740, which may include the PCM 706, the display 708, and the receiver 710. In other embodiments, circuitry 700 may include additional components, fewer components, or alternative components. For example, the circuitry 700 may include various diodes, resistors, relays, and other electronic components, as shown in FIG. 7. In some embodiments, each of the components of FIG. 7 may be operatively coupled via one or more cables or wires (e.g., electrical wires). Generally, circuitry 700 illustrates a configuration in which the standby loads 740 (e.g., PCM 706, display 708, and receiver 710) are grouped separately from the unswitched loads 712 and the switched loads 714. That is, instead of the PCM 706 and display 708 being grouped or included with unswitched loads 712 or switched loads 714, the standby loads 740 form an independent branch of circuitry 700 and may be configured to receive power from the second power supply 704 during standby modes.

In some embodiments, the first power supply 702 (e.g., lead-acid battery) may provide or supply power to the unswitched loads 712 during key-off or standby mode, while the second power supply 704 (e.g., lithium battery) may supply power to the standby loads 740. For example, the unswitched loads 712 may include components such as sensors or lights that remain powered regardless of vehicle state, and the standby loads 740 may include components such as PCM 706, display 708, and receiver 710 that similarly remain powered regardless of vehicle state. In some embodiments, the switch 722 may control the power supplied by second power supply 704 to the standby loads during standby mode. For example, switch 722 may be a double-throw switch configured to direct power between two different paths or components. For example, during operational mode, the switch 722 can activate to a first position to supply power from the first power supply 702 to the standby loads 740. Further, during standby mode, the switch 722 can activate to a second position to connect with the discharging circuit 720 and supply power from the second power supply 704 to the standby loads 740. In some embodiments, the isolator 716 may control the power supplied by the first power supply 702 to the switched loads 714 and the unswitched loads 712 during vehicle operation or standby. For example, the isolator 716 may close in operational mode to supply power from the first power supply 702 to the switched loads 714, and may further open in standby mode to disconnect the first power supply 702 from the switched loads 714.

In some embodiments, when the vehicle transitions or changes to operational mode, switch 722 may open, disconnecting the second power supply 704 from the standby loads 740. The first power supply 702 may then resume powering both the unswitched loads 712, switched loads 714, and standby loads 740. For example, during operational mode, switch 722 may close to connect the first power supply 702 to the switched loads 714 (e.g., in-cabin electronics and lighting systems), while isolator 716 continues directing power to the unswitched loads 712. Additionally, after a period of operation (e.g., 30 minutes), switch 726 in the charging circuit 724 may close such that the alternator 730 or first power supply 702 charges the second power supply 704.

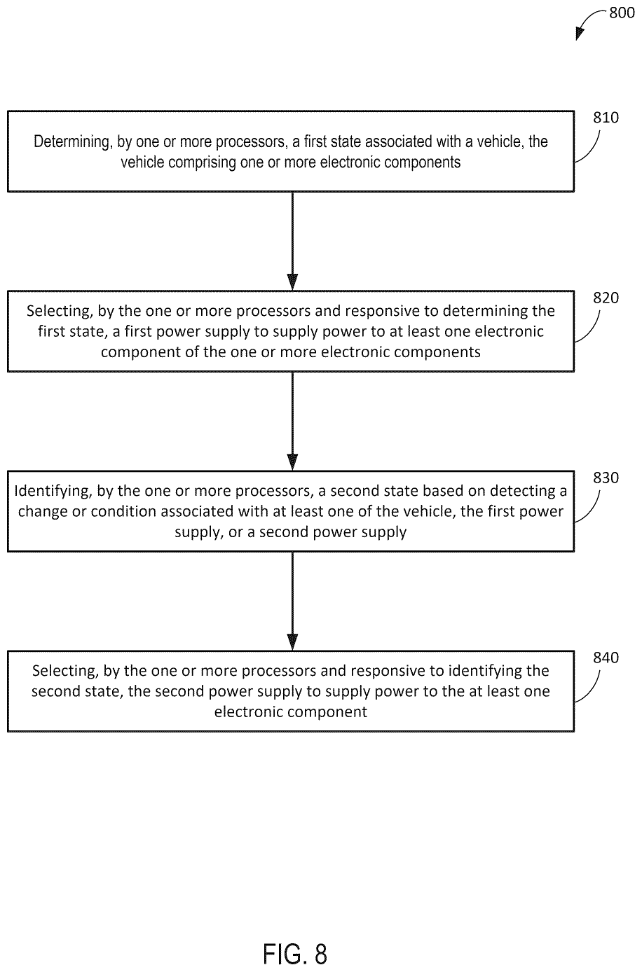

Referring to FIG. 8, a flowchart of a process 800 for switching between multiple power supplies is shown, according to an exemplary embodiment. In some embodiments, process 800 may be executed or implemented by one or more components or systems of FIGS. 1-3 and/or by one or more processors of vehicle 10. In some embodiments, process 800 may be executed or implemented by one or more components or systems of FIGS. 4-7. Generally, the steps of process 800 can be executed sequentially or in parallel (e.g., steps 820 and 830 can be performed in parallel). It should be understood that, in other embodiments, the steps of process 800 may be performed in any order, combined, and/or additional modifications implemented, such as the deletion of one or more steps and/or the addition of one or more steps. The process 800 may be a computer-implemented method.

In some embodiments, at step 810, the process 800 may include determining, by one or more processors, a first state associated with a vehicle. That is, determining may include detecting an operational mode, standby mode, or other vehicle state by receiving and analyzing data from power supplies or sensors. For example, determining may include detecting whether the vehicle is in a key-off or operational state by analyzing signals from the first power supply 502, second power supply 504, or data received from sensors monitoring the battery health or charge levels. In some embodiments, the process 800 may further include detecting signals from unswitched loads 512 or switched loads 514 to assess whether specific systems are active or inactive based on the state of the vehicle. In some embodiments, the first state may correspond with an active or operational state of the vehicle. For example, the first state corresponds with a key-on or active driving mode indicative of the vehicle being in use. Further, in some embodiments, the vehicle includes one or more electronic components. For example, the electronic components may include the PCM 506, display 508, or receiver 510, which may be activated (e.g., using power) or deactivated (not using power) depending on vehicle state.

In some embodiments, at step 820, the process 800 may include selecting, by the one or more processors and responsive to determining the first state, the first power supply to supply power to the at least one electronic component. That is, selecting may include identifying that the vehicle is in the operational mode and selecting the first power supply 502 (e.g., a lead-acid battery) to power certain electronic components included in the vehicle. For example, in the operational state, the first power supply 502 may power each of the PCM 506, display 508, and receiver 510 or additional switched or unswitched loads at step 820. Further, selecting may include operatively coupling the first power supply 502 to the electrical component(s) (e.g., via activation of a switch).

In some embodiments, at step 830, the process 800 may include identifying, by the one or more processors, a second state based on detecting a change or condition associated with at least one of the vehicle, the first power supply, or a second power supply. That is, step 830 include detecting a change or transition from an operational state to a standby state based on signals received from sensors or other components of the vehicle. For example, the second state corresponds with a key-off or non-active mode indicative of the vehicle not being in use (e.g., standby or extended standby mode). For example, identifying may include receiving data corresponding with the vehicle or included components (e.g., PCM 506, starter 532, first power supply 502, the second power supply 504, etc.) indicating that the vehicle has transitioned or changed to a key-off state. In some examples, identifying may include detecting or determining various conditions, which may include states or changes associated with battery charge levels (e.g., states of charge of the first power supply 502 and/or second power supply 504), operational statuses of electronic components (e.g., power demands of switched loads 514 and unswitched loads 512), or various additional data or factors to determine that the vehicle has entered a second state, such as a standby mode.

In some embodiments, at step 840, the process 800 may include selecting, by the one or more processors and responsive to identifying the second state, the second power supply to supply power to the at least one electronic component. That is, selecting may include identifying that the vehicle has transitioned or changed to a key-off or standby mode and activating a switch to cause the second power supply 504 (e.g., a lithium battery) to power specific electronic components, such as unswitched loads 512 or 612 and/or standby loads 740. For example, the second power supply 604 may power the PCM 606 during standby mode such that the PCM 606 continues to receive power while other loads are deactivated. Further, selecting may include operatively coupling the second power supply 504 to the electrical component(s) (e.g., via activation of a switch).

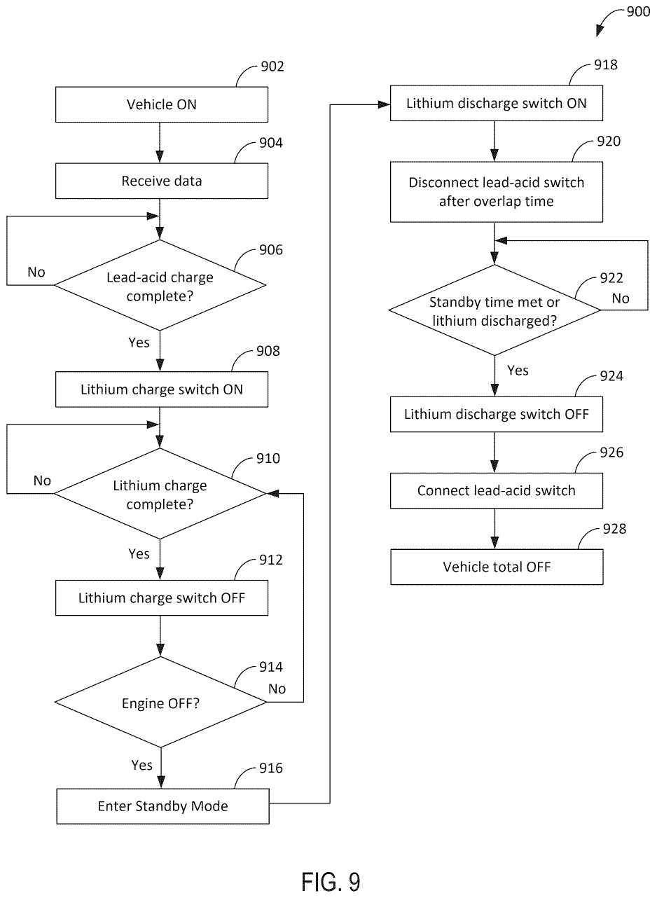

Referring to FIG. 9, a flowchart of a process 900 for switching between multiple power supplies is shown, according to an exemplary embodiment. In some embodiments, process 900 may be executed or implemented by one or more components or systems of FIGS. 1-3 and/or by one or more processors of vehicle 10. In some embodiments, process 900 may be executed or implemented by one or more components or systems of FIGS. 4-7. Generally, the steps of process 900 can be executed sequentially or in parallel (e.g., steps 902 and 904 can be performed in parallel). It should be understood that, in other embodiments, the steps of process 900 may be performed in any order, combined, and/or additional modifications implemented, such as the deletion of one or more steps and/or the addition of one or more steps. The process 900 may be a computer-implemented method.

In some embodiments, at step 902, the process 900 may include a vehicle entering an ON state. For example, entering or transitioning to an ON state may include detecting that an ignition of the vehicle is engaged, determining that a key-on signal is received, and/or activating electronic components of the vehicle. In some embodiments, at step 904, the process 900 may include receiving data. For example, receiving data may include a control system of the vehicle collecting or receiving inputs from sensors configured to monitor parameters (e.g., states of charge) associated with a lead-acid battery or lithium battery of the vehicle. In some examples, the data received at step 904 can include a charge level or charging time of the lead-acid battery and/or additional data (e.g., current power demands of the vehicle, operational status indicators from various electronic components, etc.). In some examples, the lead-acid battery of the vehicle can be configured to receive a charge or to charge during one or more of step 902 and step 904.

In some embodiments, at step 906, the process 900 may include determining if the lead-acid battery has completed charging. For example, a control system of the vehicle may collect or retrieve data associated with the lead-acid battery at step 904 and determine, based on the collected or retrieved data, a state of charge (e.g., 0%, 100%, etc.) associated with the lead-acid battery. Further, the control system may compare the battery state of charge to a predefined value or threshold to determine that the lead-acid battery charge is complete. In some examples, determining at step 906 may include comparing or evaluating additional metrics or parameters associated with the lead-acid battery (e.g., voltage, current draw, battery health, number of charging cycles, etc.) using data received from battery monitoring sensors. In some embodiments, if the lead-acid battery charge is determined to be complete (e.g., exceeds a predefined charge value or threshold) at step 906, the process 900 may continue to step 908. In some embodiments, if the lead-acid battery charge is incomplete at step 906, the process 900 may continue monitoring and repeat step 906 until the lead-acid battery reaches a full charge. That is, the process 900 may repeat step 906 during a time interval (e.g., time t<x, where x represents a time to fully charge the lead-acid battery). In some embodiments, a full or complete charge may refer to any charge level of less than or equal to 100% (e.g., 80% charge).

In some embodiments, at step 908, the process 900 may include activating a lithium-battery charge switch to an ON state. For example, in response to determining the lead-acid battery charge is complete, the vehicle may activate a switch included in a circuit to connect the lithium battery to various electronic components configured to provide power to charge the lithium battery. In some embodiments, at step 910, the process 900 may include determining if the lithium battery charge is complete. For example, a control system of the vehicle may gather data corresponding to the lithium battery, determine a lithium battery state of charge based on the gathered data, and compare the lithium battery state to a predefined threshold or value. In some embodiments, if the lithium charge is determined to be complete at step 910, the process 900 may continue to step 912. In some embodiments, if the lithium charge is incomplete at step 910, the process 900 may continue monitoring and repeat step 910 until the lithium battery reaches a full charge (e.g., during a time interval time t<y, where y represents a time to fully charge the lithium battery).

In some embodiments, at step 912, the process 900 may include deactivating the lithium charge switch. For example, a control system of the vehicle may activate a switch within an electronic circuit to disconnect the lithium battery from a charging source and prevent further charging responsive to the lithium battery reaching a target charge level. In some embodiments, at step 914, the process 900 may include determining if an engine or other power source of the vehicle is OFF. For example, the control system can analyze or identify an operational status of the vehicle by processing signals received from engine sensors that indicate whether the engine is running. In another example, the control system can receive inputs from user interface components to determine if the vehicle has been manually powered off (e.g., by an operator). In some embodiments, if the engine is determined to be OFF at step 914, the process 900 can proceed to step 916. In some embodiments, if the engine remains ON, the process 900 can return to step 910 and repeat one or more of step 910, step 912, and step 914 one or more times.

In some embodiments, at step 916, the process 900 may include the vehicle entering a standby mode. For example, a standby mode may be associated with an OFF state of the vehicle. In some examples, entering standby mode at step 916 can cause the control system to adjust power management of various electronic components to prioritize maintaining subsets of electronic components of the vehicle while conserving energy and preserving battery health. For example, entering standby mode at step 916 may include deactivating the lead-acid battery and activating the lithium battery to power standby loads, as further described herein.

In some embodiments, at step 918, the process 900 may include activating the lithium discharge switch. For example, the control system can activate a switch within a circuit of the vehicle to connect the lithium battery to components that consume or use power during standby mode. In some embodiments, at step 920, the process 900 may include disconnecting the lead-acid battery switch after a predetermined overlap time. The overlap period can include a time interval or period during which the lithium battery and lead-acid battery are simultaneously connected to and supply current to electronic components. For example, during the overlap period, the lithium battery and the lead-acid battery can provide a combined output to deliver power to vehicle components, and after the overlap period, the lithium battery may continue providing power while the lead-acid battery is disconnected. For example, the lead-acid battery may power one or more electronic components at step 918 or 920 while the vehicle initially enters standby mode to prevent interruptions to vehicle functions. In some embodiments, if the overlap period has elapsed, the process 900 may continue to step 922. In some embodiments, if the overlap period has not elapsed, the process 900 may include repeating step 920.

In some embodiments, at step 922, the process 900 may include determining whether a standby time has been met or if the lithium battery has discharged. The standby time can refer to a duration or interval during which the vehicle is configured to remain in standby mode (e.g., 24 hours). For example, the vehicle control system may monitor battery parameters or performance data to identify the vehicle has remained in the standby mode for a period of time or to determine a discharge level or state of charge associated with the lithium battery. In some embodiments, if the standby time is not met and the lithium battery is not discharged, the process 900 can include repeating step 922 by maintaining standby mode and continuously assessing the elapsed standby time or lithium battery charge level. In some embodiments, if the standby time is met or the lithium battery is discharged, the process 900 may continue to step 924. For example, the process 900 may continue to step 924 if the standby duration has elapsed or if the charge level of the lithium battery falls below a threshold.

In some embodiments, at step 924, the process 900 may include deactivating the lithium discharge switch to an OFF state. For example, the control system may activate a switch within a circuit of the vehicle to disconnect the lithium battery and prevent the lithium battery from supplying power to various components powered by the lithium battery during standby mode. In some embodiments, at step 926, the process 900 may include connecting the lead-acid switch. For example, the control system may activate a switch within a circuit to cause the lead-acid battery to supply power to vehicle loads that were previously powered by the lithium battery. That is, step 926 may include the control system reconnecting the lead-acid battery to supply power to one or more operational components and/or standby components. In some embodiments, at step 928, the process 900 may include the vehicle entering a total or complete OFF state. For example, standby mode may refer to a mode where selected components remain active to conserve energy, and a total or complete OFF state may refer to a state in which components are fully powered down. That is, in the complete OFF state, both the lead-acid battery and the lithium battery may be disconnected to prevent the lead-acid battery and the lithium battery from supplying power to one or more vehicle components.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein.

What is claimed is:

1. A computer-implemented method comprising:
determining, by one or more processors, a first state associated with a vehicle, the vehicle comprising one or more electronic components;
selecting, by the one or more processors and responsive to determining the first state, a first power supply to supply power to at least one electronic component of the one or more electronic components;
identifying, by the one or more processors, a second state based on detecting a change or condition associated with at least one of the vehicle, the first power supply, or a second power supply; and
selecting, by the one or more processors and responsive to identifying the second state, the second power supply to supply power to the at least one electronic component.

2. The computer-implemented method of claim 1, wherein selecting the second power supply comprises:
activating, by the one or more processors, at least one switch of the vehicle, wherein the at least one switch operatively couples the second power supply with the at least one electronic component.

3. The computer-implemented method of claim 1, wherein the first power supply is a lead-acid battery and the second power supply is a lithium battery.

4. The computer-implemented method of claim 1, wherein the first state corresponds with the vehicle being in an operational mode, and wherein the second state corresponds with the vehicle being in a standby mode.

5. The computer-implemented method of claim 1, wherein the one or more electronic components comprise one or more switched loads and one or more unswitched loads, wherein the one or more unswitched loads comprise the at least one electronic component, and wherein selecting the first power supply comprises:
deactivating, by the one or more processors, the second power supply to prevent power from the second power supply to the one or more unswitched loads; and
activating, by the one or more processors, the first power supply to power the one or more switched loads and the one or more unswitched loads.

6. The computer-implemented method of claim 5, wherein selecting the second power supply comprises:
deactivating, by the one or more processors, the first power supply to prevent power from the first power supply to the one or more switched loads and the one or more unswitched loads; and
activating, by the one or more processors, the second power supply to power the one or more unswitched loads.

7. The computer-implemented method of claim 1, wherein the one or more electronic components comprise one or more switched loads, one or more unswitched loads, and one or more standby loads, wherein the one or more standby loads comprise the at least one electronic component, and wherein selecting the first power supply comprises:
deactivating, by the one or more processors, the second power supply to prevent power from the second power supply to the one or more standby loads; and
activating, by the one or more processors, the first power supply to power the one or more switched loads, the one or more unswitched loads, and the one or more standby loads.

8. The computer-implemented method of claim 7, wherein selecting the second power supply comprises:
deactivating, by the one or more processors, the first power supply to prevent power from the first power supply to the one or more standby loads and the one or more switched loads, wherein the first power supply powers the one or more unswitched loads; and
activating, by the one or more processors, the second power supply to power the one or more standby loads.

9. A vehicle comprising:
one or more electronic components;
a first power supply;
a second power supply; and
one or more processors configured to:
determine a first state associated with the vehicle;
select, responsive to determining the first state, the first power supply to supply power to at least one electronic component of the one or more electronic components, wherein the first power supply is operatively coupled with the at least one electronic component;
identify a second state based on detecting a change or condition associated with at least one of the vehicle, the first power supply, or a second power supply; and
select, responsive to identifying the second state, the second power supply to supply power to the at least one electronic component, wherein the second power supply is operatively coupled with the at least one electronic component.

10. The vehicle of claim 9, the one or more processors configured to, in selecting the second power supply:
activate at least one switch of the vehicle, wherein the at least one switch operatively couples the second power supply with the at least one electronic component.

11. The vehicle of claim 9, wherein the first power supply is a lead-acid battery and the second power supply is a lithium battery.

12. The vehicle of claim 9, wherein the first state corresponds with the vehicle being in an operational mode, and wherein the second state corresponds with the vehicle being in a standby mode.

13. The vehicle of claim 9, wherein the one or more electronic components comprise one or more switched loads and one or more unswitched loads, wherein the one or more unswitched loads comprise the at least one electronic component, and wherein the one or more processors are configured to, in selecting the first power supply:
deactivate the second power supply to prevent power from the second power supply to the one or more unswitched loads; and
activate the first power supply to power the one or more switched loads and the one or more unswitched loads.

14. The vehicle of claim 13, the one or more processors further configured to, in selecting the second power supply:
deactivate the first power supply to prevent power from the first power supply to the one or more switched loads and the one or more unswitched loads; and
activate the second power supply to power the one or more unswitched loads.

15. The vehicle of claim 9, wherein the one or more electronic components comprise one or more switched loads, one or more unswitched loads, and one or more standby loads, wherein the one or more standby loads comprise the at least one electronic component, and the one or more processors further configured to, in selecting the first power supply:
deactivate the second power supply to prevent power from the second power supply to the one or more standby loads; and
activate the first power supply to power the one or more switched loads, the one or more unswitched loads, and the one or more standby loads.

16. The vehicle of claim 15, the one or more processors further configured to, in selecting the second power supply:
deactivate the first power supply to prevent power from the first power supply to the one or more standby loads and the one or more switched loads, wherein the first power supply powers the one or more unswitched loads; and
activate the second power supply to power the one or more standby loads.

17. A system comprising:
one or more processors configured to:
determine a first state associated with vehicle, the vehicle comprising one or more electronic components;
select, responsive to determining the first state, a first power supply to supply power to at least one electronic component of the one or more electronic components, wherein the first power supply is operatively coupled with the at least one electronic component;
identify a second state based on detecting a change or condition associated with at least one of the vehicle, the at least one electronic component, the first power supply, or a second power supply; and
select, responsive to identifying the second state, the second power supply to supply power to the at least one electronic component, wherein the second power supply is operatively coupled with the at least one electronic component.

18. The system of claim 17, the one or more processors configured to, in selecting the second power supply:
activate at least one switch of the vehicle, wherein the at least one switch operatively couples the second power supply with the at least one electronic component.

19. The system of claim 17, wherein the first power supply is a lead-acid battery and the second power supply is a lithium battery.

20. The system of claim 17, wherein the first state corresponds with the vehicle being in an operational mode, and wherein the second state corresponds with the vehicle being in a standby mode.
